(19) United States
(12) Patent Application Publication
(10) Pub. No.: US 2002/0073218 A1
(43) Pub. Date: Jun. 13, 2002

(54) STREAM DEVICE MANAGEMENT SYSTEM FOR MULTIMEDIA CLIENTS IN A BROADCAST NETWORK ARCHITECTURE

(76) Inventors: BILL J. ASPROMONTE, SANTA CRUZ, CA (US); ALTAN J. STALKER, SAN JOSE, CA (US); LEE SALZMAN, CENTERPORT, NY (US); JOSEPH MINCONE, COLD SPRING HARBOR, NY (US); JOHN MINCONE, NEW YORK, NY (US); ANDRE HOLLINGER, NEW YORK, NY (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/219,011

(22) Filed: Dec. 23, 1998

(51) Int. Cl. G06F 15/16

(52) U.S. Cl. 709/231; 709/203

(57) ABSTRACT

A stream device management system is provided for supporting applications that access a variety of stream devices associated with a conventional set-top box. More specifically, the stream device management system includes a stream manager configured to identify a plurality of stream devices and to store a device identifier for each of these stream devices, and a shared memory for storing stream data associated with each of the stream devices. To initiate communication with a first stream device, a first application sends a device identifier indicative of the first stream device to the stream manager. In response to receiving the device identifier, the stream manager communicates an address for the shared memory associated with the first stream device to the first application. Lastly, the application uses this address to access the stream data.

### BACKGROUND OF THE INVENTION

The present invention relates generally to an operating system for a multimedia client, and more particularly to a stream device management system for supporting applications that interact with a plurality of stream devices via a stream manager in a network architecture.

The Federal Communications Commission (FCC) has promulgated a new set of television broadcasting standards for implementing digital television (DTV). It is expected that digital television will eventually replace the current NTSC standard in homes across the country and throughout the world. Digital TV offers a number of advantages over the conventional NTSC standard, including high-definition pictures, vastly improved user interactivity, support for Internet email resources and the like.

We anticipate that the new digital TV standard will promote the confluence of computer and television technologies with far reaching impact. Thus, the personal computer will someday function as home entertainment multimedia system and the television will function as a node on a variety of computer networks ranging from the home automation network to the Internet. While there are a number of different possible physical packages for deploying digital television technology, currently most popular is the set-top box.

In the early days, the set-top box served primarily as the tuner and signal descrambler for cable TV. More recently, companies such as Scientific Atlanta have developed far more sophisticated set-top boxes. Interactive digital set-top boxes provide an open platform for developing and delivering interactive services and multimedia content to consumers across a broadcast network. To provide the power of the personal computer, these sophisticated set-top boxes incorporate a full-fledged computer operating system. Requirements such as management of high data throughput, effective management of memory in a constrained consumer device, and support for a secure environment drive the decision to architect an innovative operating system for use in set-top boxes.

In a set-top box environment, the operating system generally consists of layers of interconnected software modules designed to minimize redundancy and optimize multimedia processing. For instance, each hardware device associated with the set-top box is abstracted into a software device module. These software device modules are responsible for media delivery and manipulation of a particular hardware device (e.g., RAM, serial ports, SCSI hard drives, ect.) associated with the set-top box. Therefore, it is desirable that the operating system be designed for smooth and efficient porting between different hardware platforms. Thus, the operating system provides a device management system which serves as an interface between these software device modules and the applications residing on the set-top box.

In addition, the set-top box offers a challenging site to deploy a computer operating system. Memory resources with the set-top box are quite limited. Applications supported by the operating system must use memory in a highly efficient manner. Thus, it is also desirable that this device management system provide an efficient means for applications to use the typically small memory footprint associated with the set-top box.

### SUMMARY OF THE INVENTION

In accordance with the teachings of the present invention, a stream device management system is provided for supporting applications that access a variety of stream devices associated with a conventional set-top box. More specifically, the stream device management system includes a stream manager configured to identify a plurality of stream devices and to store a device identifier for each of these stream devices, and a shared memory for storing stream data associated with each of the stream devices. To initiate communication with a first stream device, a first application sends a device identifier indicative of the first stream device to the stream manager. In response to receiving the device identifier, the stream manager communicates an address for the shared memory associated with the first stream device to the first application. Lastly, the application uses this address to access the stream data.

### BRIEF DESCRIPTION OF THE DRAWINGS

FIG. 1 is a block diagram illustrating the basic software components for an operating system in accordance with the present invention;

FIG. 2 is a diagram showing a preferred embodiment of the stream device management system of the present invention;

FIG. 3 is a flowchart showing how to initialize a stream device data structure associated with a stream manager of the present invention;

FIG. 4 is a flowchart showing how to initiate communication between an application and a stream device using the stream manager of the present invention; FIG. 5 is a diagram illustrating a conventional Read operation between an application and a stream device; and

FIG. 6 is a diagram illustrating an AllocRead operation between an application and a stream device in accordance with the present invention.

### DETAILED DESCRIPTION OF THE PREFERRED EMBODIMENT

The following description of the present invention is merely exemplary in nature and is in no way intended to limit the invention or its uses. Moreover, the following description, while depicting an operating system designed to reside on a conventional set-top box, is intended to adequately teach one skilled in the art to make and use an operating system for a variety of consumer multimedia clients including, but not limited to, intelligent televisions, Internet terminals and advanced DVD players.

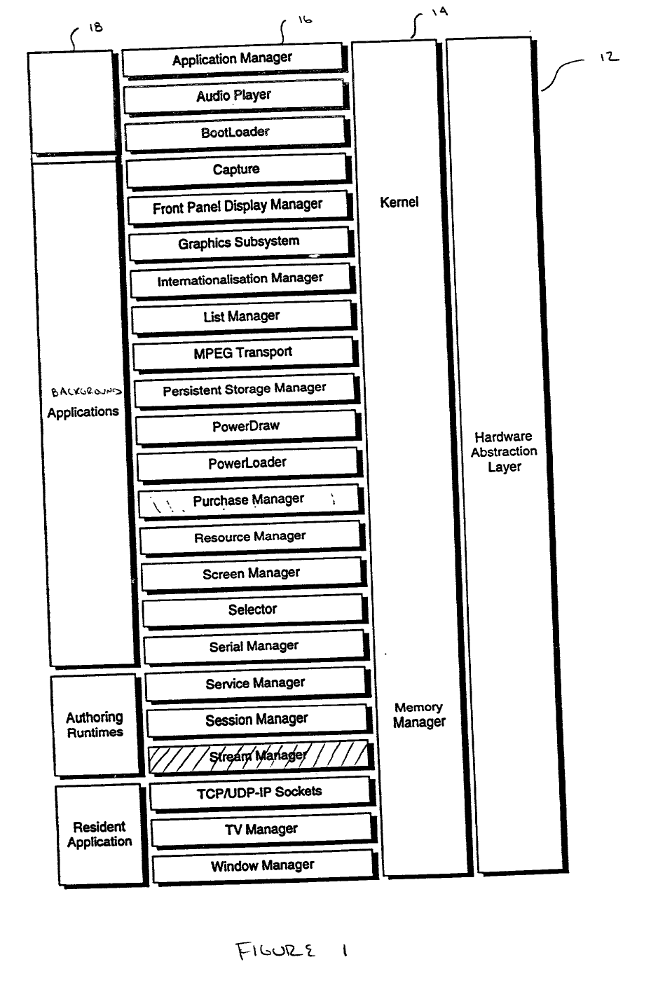

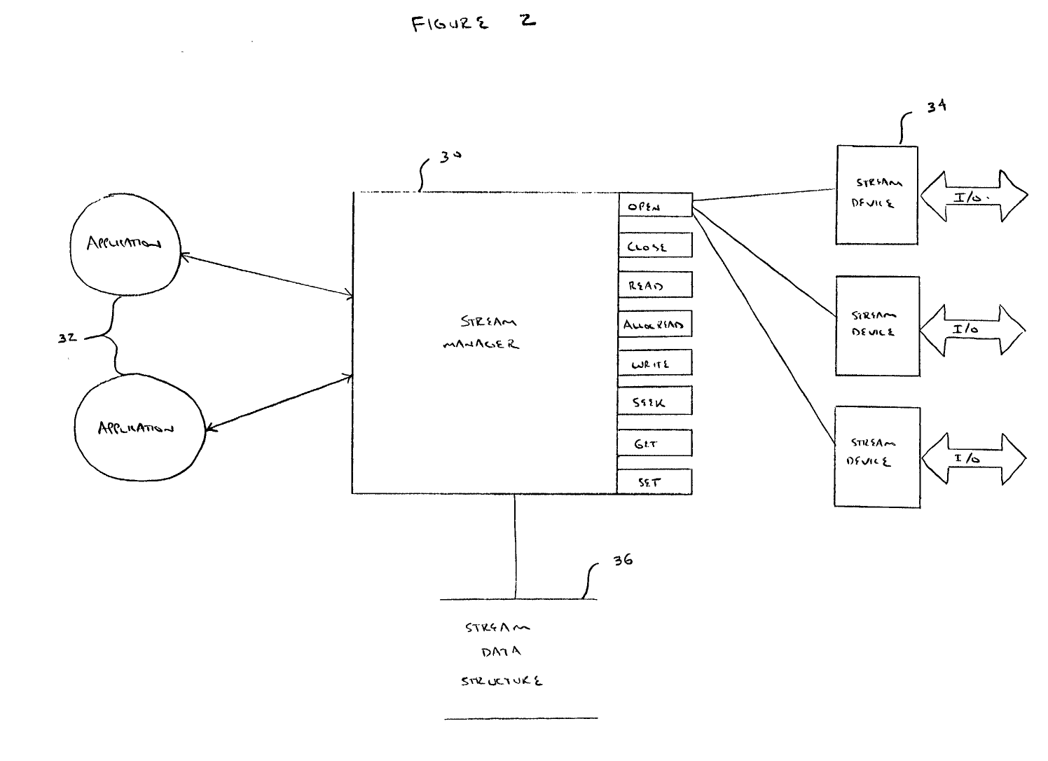

FIG. 1 depicts the basic software components of an operating system 10 in accordance with the present invention. The multitasking operating system 10 is designed to address the high-performance demands of media-centric, real-time applications being delivered through a set-top box. The operating system provides an open, scalable platform for developing and delivering multimedia content to consumers across broadcast and client/server networks. The software architecture for the operating system 10 is comprised from layers of interconnected modules designed to minimize redundancy and optimize multimedia processing in an interactive, network setting. The layers of the architecture include a hardware abstraction layer 12, a core layer 14, an application support layer 16 and an application layer 18.

Each hardware device associated with the multimedia client is abstracted into a software device module that resides in the hardware abstraction layer 12. Each of these device modules are responsible for media delivery and manipulation between a hardware device and the remainder of the operating system. Well defined application program interfaces (APIS) supported by each device module separate the hardware dependencies of each device from the portable operating system facilities, and thereby mask the idiosyncrasies of different hardware implementations.

A kernel and memory manager residing in the core layer 14 provide the base functionality needed to support an application. A fully preemptive, multithreaded, multitasking kernel is designed to optimize both set-top memory footprint and processing speed. Since the operating system will reside on consumer units, it has been designed to exist in a ROM-based system with a very small footprint (e.g., 1 MB). In addition, the kernel has also been created to take advantage of 32-bit Reduced Instruction Set Computer (RISC) processors which enable high-speed transmission, manipulation and display of complex media types. On the other hand, a memory manager provides an efficient allocation scheme to enable the best performance from limited memory resources. Because embedded processors are likely to be the mainstay of consumer digital hardware implementations, the memory model requires little memory management unit support. The core layer 14 also provides an integrated event system and a standard set of ANSI C utility functions.

Built on top of the core layer 14 is an application support layer 16. This set of support modules provides higher-level processing functions and application services. Application management, session management, and tuner management are a few examples of these services. At the highest application level 18, at least one application, referred to as a resident application is always resident on a set-top box. The application level 18 also provides the necessary capabilities for authoring applications and for managing resources (e.g., the tuner) between the resident application and other background applications residing on the set-top box.

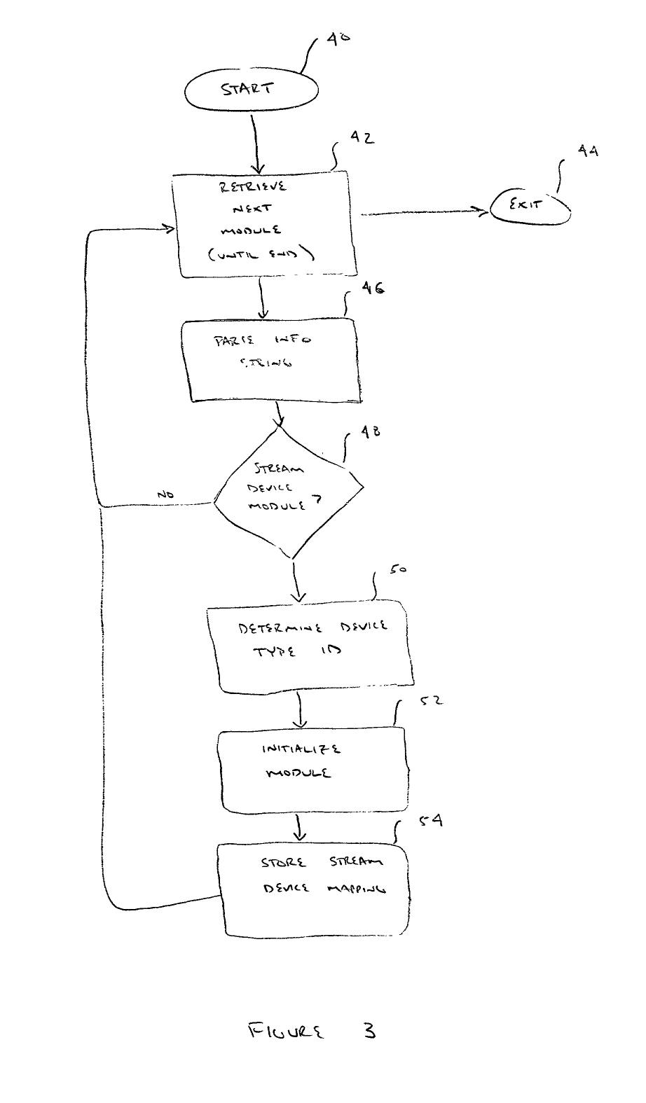

A device management system residing within the context of the application support layer 16 provides a consistent interface to the variety of stream devices supported by a typical set-top box. More specifically, a stream manager 30 facilitates communication between an application 32 and a stream device 34 as shown in FIG. 2. For purpose of the following discussion, the term “application” signifies any software module, including the operating system, that may reside on the set-top box, and the term “stream” generally refers to any byte-oriented data (e.g. information in RAM or a file in an HTTP server) which may be accessed through a stream device 34. Although each stream device 34 has its own unique characteristics, the means for accessing these stream devices are similar. Therefore, stream manager 30 provides a standard set of APIs (e.g., read from a stream, write to a stream, ect.) to interact with each type of stream device 34. In this way, stream manager 30 is able to support several types of stream devices, including, but not limited to, memory, (SCSI) hard drives, serial ports, file transfer programs (FTP), hypertext transfer programs (HTTP), MPEG transport streams, and a broadcast file system (BFS). In addition, a stream data structure 36 accessible to the stream manager 30 is used to maintain a list of the valid stream devices associated with a particular multimedia client.

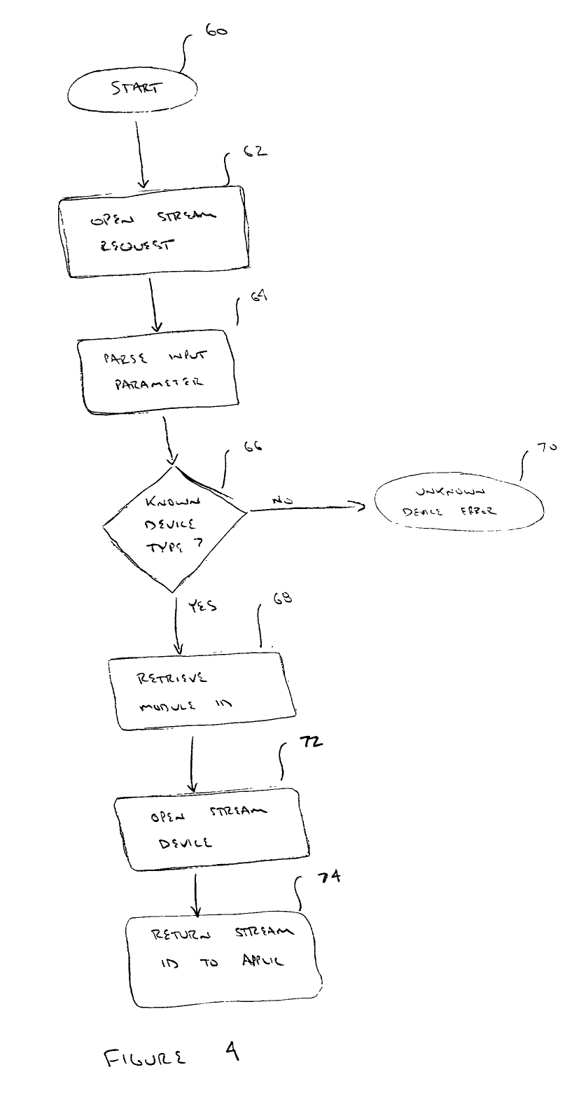

As previously discussed, the operating system 10 is comprised of a plurality of modules, including a software abstraction module for each stream device. During boot up of the operating system, each of the stream device modules are dynamically recognized and read into the stream data structure as shown in FIG. 3. First, a loader module retrieves and examines every module associated with the operating system in block 42. To examine each module, block 46 parses an information string that contains data about each module. When decision block 48 detects a module that corresponds to a stream device (i.e., Group ID=“stream”) it proceeds with initialization of the stream data structure; otherwise the next module is retrieved in block 42. Once all of the modules have been retrieved, processing is terminated in exit block 44.

For each stream device module, block 50 determines a device type identifier (e.g., “ftp”, “memory”, “bfs”, ect.) by parsing the remainder of the information string. A mapping between a device type id and the software device module that contains the code for the stream device is maintained in the stream data structure. However, before block 54 stores this mapping in the stream data structure, block 52 executes an initialization method for that stream device. The process is repeated until the loader module has evaluated each module.

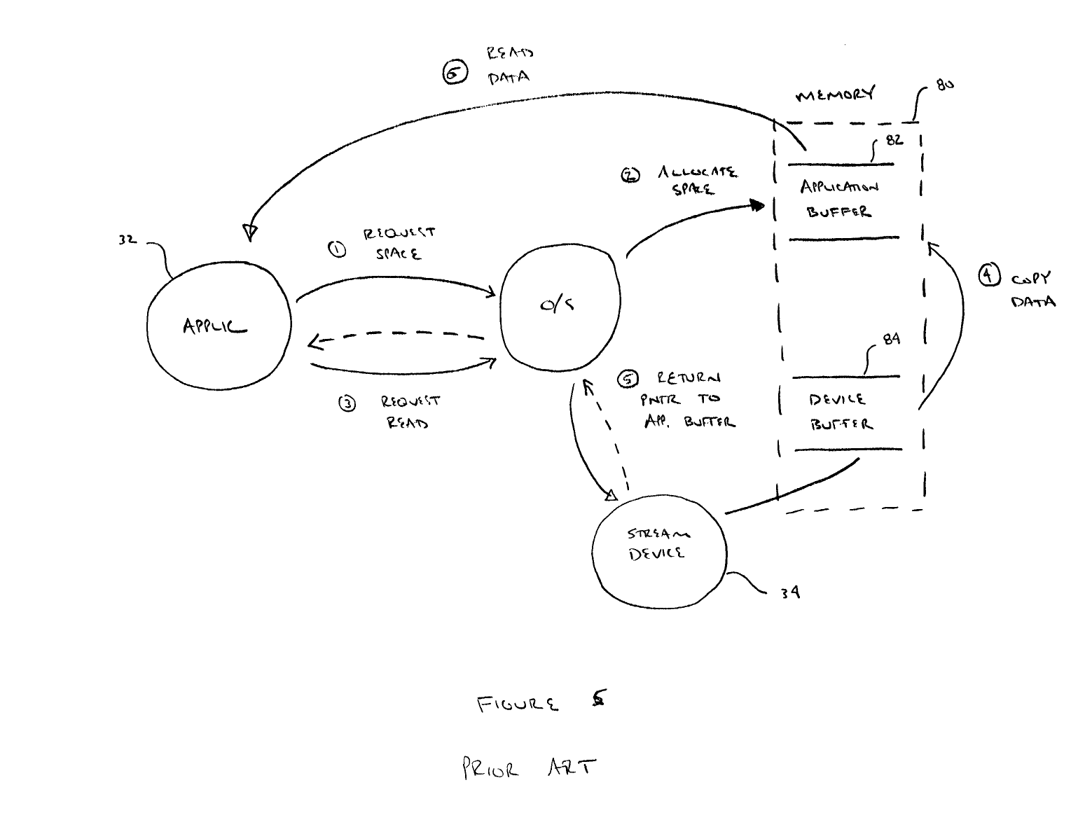

At this point, stream manager 30 is operative to initiate communication between an application 32 and a stream device 34. Referring to FIG. 4, stream manager 30 supports an Open API that allows applications to gain access to a stream device. When opening a stream in block 62, the requesting application provides an input parameter to stream manager. Rather than using a data structure, this input parameter is a text-based ASCII string in the form of a conventional URL (e.g., serial0:bps=19200;data=7;parity=0;stop=2). Because a text-based message is used to open the stream, variations in parameters for different device types or additions of new device types are easily be supported by the stream manager 30. A URL is composed of a scheme part and a scheme specific part. In the present invention, the scheme maps to a device type (e.g., serial0:///) while the scheme specific part maps to other device specific information. Thus, the device type identifier is a standard scheme. By using a URL based approach, the present invention is able to support any Internet based protocol without significant changes in the architecture.

Next, block 64 parses the input parameter to determine the device type id as provided by the requesting application. Using the device type id, decision block 66 searches the stream data structure for the corresponding stream device module. For a known device type, block 68 retrieves the module id from the stream data structure; is whereas for an unknown device type processing branches to a diagnostic or error routine. Using this retrieved module id (as well as the other device specific access information), stream manager 30 is then able to gain access to the requested stream device. An OPEN API supported by each stream device is called in block 72. It should be noted that each of the standard APIs (e.g., OPEN, WRITE, READ, ect.) supported by the stream devices have a well know offset within the stream device module. Thus, only a module id is needed by the stream manager to initially access a stream device.

However, since a stream device typically supports multiple streams and an application can access one or more streams on the same or different stream devices, stream manager 30 also needs a means for identifying the particular stream it is accessing in relation to a stream device. Therefore, in response to each open request, a unique stream instance id is generated by the requested stream device and then communicated back to stream manager 30. In this way, a device module id in combination with a stream instance id (referred to as a stream id) uniquely identifies each stream.

Lastly, stream manager 30 returns the stream id to the application in block 74. For all subsequent access to an open stream, the application will use the stream id when calling the stream manager. Rather than perform the above-described mapping process, stream manager 30 will also use the stream id to directly accesses the open stream and its corresponding stream device.

Once an application has established communication with a stream device, it may perform various data access operations. FIG. 5 illustrates the processing steps associated with a typical READ function. Prompted by a request from an application, the operating system allocates an application buffer space 82 in a shared memory 80 for each read request made by an application 32. When the application performs the read operation, the stream device 34 copies the requested information from its device buffer space 84 to the previously allocated application buffer space 82, and then passes an address (i.e., pointer) for application buffer space 82 back through the operating system to the requesting application 32. Using this address, the application 32 can access the data in the application buffer space 82. This approach is followed regardless of the type of information being requested from the device.

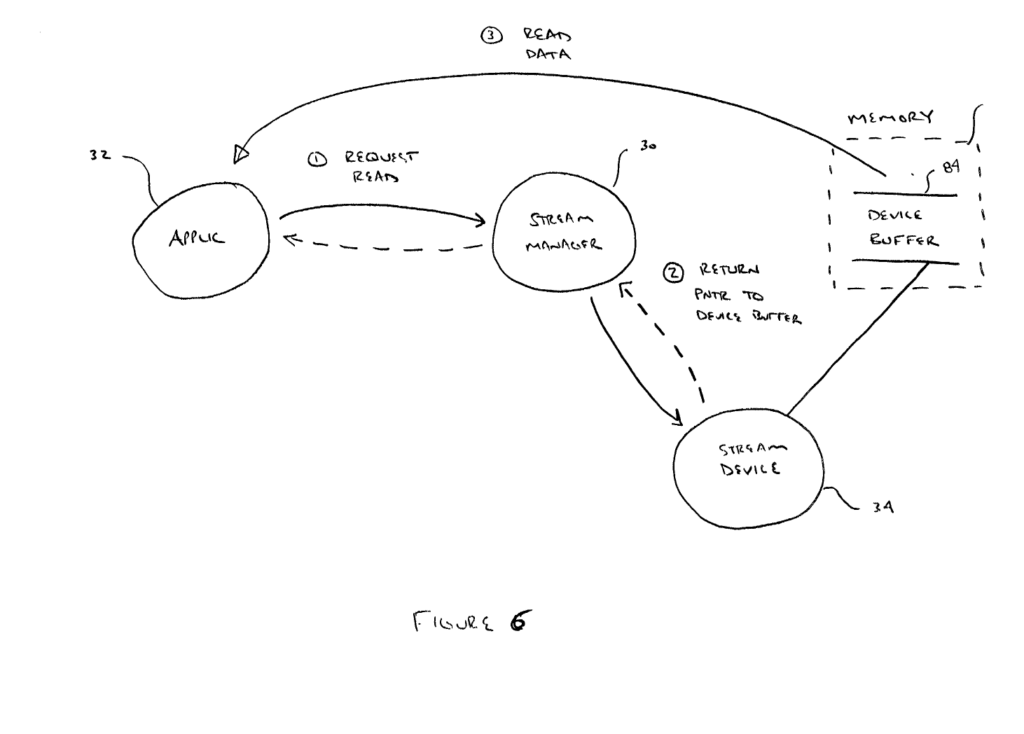

In addition to this conventional READ method, stream manager 30 of the present invention also provides a more efficient means for accessing stream data from a stream device. An Allocate Read Only (“AllocReadOnly”) function is provided by stream manager 30 as depicted in FIG. 6. Rather than use the standard READ API, an application 32 can also call the AllocReadOnly API when it is acceptable to receive read-only access to the stream data. In response, stream manager 30 will interact with the appropriate stream device 34 to provide the requesting application an address (e.g. a handle or a pointer) for the requested stream data. To do so, the AllocReadOnly API returns a handle to the stream device's internal buffer 84. In some cases, this internal buffer might be created from direct memory access.

Since the stream data is only being read, not manipulated, by the application (e.g., font information), there is no need to make an additional copy of the stream data in memory. In this way, the AllocReadOnly operation eliminates the additional copy step associated with a typical READ operation, and thus reduces memory allocation within the set-top box. Using the returned address, the requesting application 32 can directly read the stream data from the device's buffer space in shared memory. Once done with the data, the application 32 is responsible for freeing the memory space. An additional feature of the ReadAllocOnly function is that it allows the stream device to satisfy multiple requests for the same data. As opposed to multiple applications each having copies of the same data, multiple requesting applications receive the same address and thus read the same data. Therefore, it is preferable to architect an application so that read-only access is acceptable.

The foregoing discloses and describes merely exemplary embodiments of the present invention. One skilled in the art will readily recognize from such discussion, and from the accompanying drawings and claims, that various changes, modifications and variations can be made therein without departing from the spirit and scope of the present invention.

What is claimed is:

1. A device management system for supporting applications that reside on a multimedia client, the applications interacting with a plurality of stream devices associated with the multimedia client, comprising:
a stream manager being configured to identify the plurality of stream devices and store a device identifier for each of said stream devices;
a first application being operative to initiate communication between a first stream device and said first application by sending a device identifier to said stream manager, said device identifier indicative of said first stream device; and
said stream manager being operative, in response to receiving a device identifier from said first application, to stream data between said first application and said first stream device.

2. The device management system of claim 1 wherein said device identifier includes a device type identifier and device access information for said first stream device.

3. The device management system of claim 1 wherein said device identifier is a Uniform Resource Locator (URL).

4. The device management system of claim 1 further comprises a shared memory accessible to said first application and said first stream device for storing stream data, said stream manager being operative to communicate an address for said shared memory to said first application and said first application using said address to read the stream data.

5. The device management system of claim 4 wherein said stream manager being operative to communicate said address for said shared memory to a second application and said second application using said address to read the stream data.

6. A method for accessing stream data from a stream device by an application residing on a multimedia client, comprising the steps of:
configuring a stream manager to identify a plurality of stream devices associated with the multimedia client and to store a device identifier for each of said stream devices;
requesting access to a first stream device by a first application residing on the multimedia client, said first application sending a first device identifier indicative of a first stream device to said stream manager;
determining an address for stream data associated with said first stream device by said stream manager in response to receiving said first device identifier from said first application, the stream data being stored in a shared memory on the multimedia client;
communicating said address from said stream manager to said first application; and
accessing the stream data by said first application using said address.

7. The method of claim 6 wherein the step of requesting access to a first stream device further comprises using a device type identifier and device access information for said first stream device as said first device identifier.

8. The method of claim 6 wherein the step of configuring a stream manager further comprises using a Uniform Resource Locator (URL) as said device identifier.

9. The method of claim 6 further comprises the steps of communicating said address for said shared memory to a second application and accessing the stream data by said second application using said address.
